(19) United States
(12) Patent Application Publication
(10) Pub. No.: US 2009/0154345 A1
(43) Pub. Date: Jun. 18, 2009

(54) METHOD AND NETWORK NODES FOR REPORTING AT LEAST ONE DROPPED-OUT CONNECTION PATH WITHIN A COMMUNICATION NETWORK

(75) Inventors: Gero Schollmeier, Gauting (DE); Christian Winkler, Muenchen (DE)

Correspondence Address: K&L Gates LLP, P.O. BOX 1135, CHICAGO, IL, 60690, US

(73) Assignee: NOKIE SIEMENS NETWORKS GMBH & CO KG, Muenchen (DE)

(21) Appl. No.: 12/390,859

(22) Filed: Feb. 23, 2009

Related U.S. Application Data
(63) Continuation of application No. 10/566,010, filed on Jan. 25, 2006, now abandoned.

(30) Foreign Application Priority Data
Jul. 25, 2003 (DE) 10334104.8

(51) Int. Cl. G06F 11/00

(52) U.S. Cl. 370/228

(57) ABSTRACT

A network node in the communication network is a target network node, connected by a first communication path with at least one first and one second network node, connected to each other by means of a further communication path. A routing table is held in each network node. The direct communication path from the first network node to the target network node is entered in the routing table of the first network node as the primary routing path and the path leading from the first network node to the second network node and then to the target network node is entered as the reserve routing path. An analogous entry is made in the routing table of the second network node. The relevant reserve routing path is only used on disruption of the primary routing path. A disruption in the primary communication path, provided between the first network node and the target network node is reported by the first network node, by means of a message sent to the second network node. This controls the second network node such that, on a drop-out of the primary connection path thereof to the target network node, a transmission of data packets to the target network node by means of the reverse routing path, leading from the second network node to the target network node via the first network node, is prevented.

### CROSS REFERENCE TO RELATED APPLICATIONS

This application is a continuation of, claims priority to and claims the benefit of U.S. patent application Ser. No. 10/566,010 filed on Jan. 25, 2006, in which Ser. No. 10/566,010 is a 371 of International Application No. PCT/EP2004/051540, filed on Jul. 19, 2004, which claims the benefit of German Application No. 10334104.8 filed on Jul. 25, 2003 and claims the entire contents which are incorporated herein.

### FIELD OF INVENTION

The invention relates to a method and a network node for reporting a dropped-out connection path within a communication network.

### BACKGROUND

Different routing methods are used for routing or transmission of data packets with a destination address, such as Internet Protocol packets, abbreviated to IP packets, or Protocol Data Units, abbreviated to PDUs, from a transmitter to a receiver in a packet switching data network featuring a number of network nodes, for example routers, switches or gateways, such as Internet Protocol networks, abbreviated to IP networks or Open System Interconnect networks, abbreviated to OSI networks. Routing determines the path on which the data packets arrive at the receiver or destination, destination network node or destination system respectively from the transmitter.

Known routing methods are static, semi-dynamic or dynamic routing implemented by protocols such as RIP (Routing Information Protocol), OSPF (Open Shortest Path First) or EIGRP (Enhanced Interior Gateway Routing Protocol) for IP networks or IS-IS Routing in accordance with ISO 10589 for OSI networks.

With these protocols the data packets are generally transmitted via the shortest or most effective path from the transmitter to receiver or destination respectively. Alternate paths are only computed or determined and used here in the event of errors.

In order to achieve a higher level of fault tolerance in the transmission of data packets what is known as multipath routing is used. In the method consecutive packets or groups of packets known as flows corresponding to a defined traffic distribution, which is determined in each case by predetermined traffic distribution weights, are transmitted via different paths or a number of paths from the transmitter to the receiver.

The traffic distribution weights define the traffic load per path for a destination address The traffic distribution weight is usually a value between 0 and 1, with 0 standing for no traffic and 1 for maximum traffic on a link or a path. A traffic distribution weight of 1 means that all packets are sent over this path. With multipath routing, in which a number of paths are available the traffic is divided up on the basis of the weights. The total of the traffic distribution weights to a destination in a network node accordingly produces a figure of 1, i.e. 100% of the traffic. Other weighting systems can also be used for traffic distribution, for example percentage figures between 0% and 100%.

This will be illustrated by an example. If for example a network node or a router or possesses three paths to a destination or a receiver the traffic can be divided up equally over all three paths. Each path would then be given in a traffic distribution weight of around 0.33. This would mean that a third of all packets or flows will be sent over a path in each case. Other distributions of also possible, for example 0.5 for the first, 0.3 for the second and 0.2 for the third path. With this distribution 50% of the packets are sent over the first path, i.e. every second packet is forwarded via this path, 30% of the packets over the second path and 20% of the packets over the third path. The distribution can be determined in accordance with the desired traffic flow, in accordance with the utilization of the connections, distances per link, number of nodes to the destination or in accordance with other criteria.

With multipath routing there must be a) more than one path in a network node, i.e. at least one alternate path available to the destination. In this way a fast local reaction to link dropouts can be made possible. Furthermore b) the chaining of the multipath routing paths between the network node and via a number of network nodes may not result in loops. Routing loops lead to circulation of packets in the network. Circulating packets increase the load on the links and network nodes in the data network, but also reduce the transport capacity of the network and lead to significant unnecessary packet delays or to packet losses.

Conditions a) and b) act against each other to the extent that the avoidance of routing loops frequently leads to a restriction of the possible and usable multipath paths to a destination.

This will be illustrated by an example. FIG. 1 shows an arrangement of a part of a packet switching data network, for example an Internet protocol (IP) network, consisting of three network nodes R1, R2, R3, such as routers, switches, gateways or other similar switching devices which are each connected via connections or links L12, L13, L32 to each other in a triangle. The network nodes R1 and R3 have connections to a part of the data network not shown, via which they receive data packets. These data packets are intended for a destination D or for an associated destination node which is connected to network node R2 and can only be reached via this node.

Data packets received by network node R1 for the destination D are sent via the connection L12 to network node R2 and are forwarded to the destination D. Likewise data packets received from the network node R3 for the destination D are sent via the connection L32 to the network node R2 and forwarded to the destination D.

Furthermore packets are taken into account which are sent via the network node or router R1 and the connection L12 to the network node or router R2 in order to be forwarded from the network node R2 to its destination D. It makes no difference here whether for these packets, in addition to the path via the Router R1, there would also have been other paths through the network in question. At the moment, since a packet has arrived at network node R1 and is to be forwarded to the network node R2, the following problem arises: With normal routing, known as shortest-path routing, the network node R1 would always forward packets to network node R2 via the connection L12 and the network node R3 would always forward packets to the network node R2 via the connection L32. The routing tables relating to the forwarding of packets bearing the destination address D would thus be as follows:

In node R1:

| Destination | Next node |
|---|---|
| D | R2 |

In Node R3:

| Destination | Next node |
|---|---|
| D | R2 |

To allow a fast local reaction to link dropouts in the node concerned the following alternate paths would be the obvious choices for multipath routing or multipath forwarding: The network node R1 could initially also forward packets to network node R2 via the connection L13 to network node R3, if they are forwarded from there via the connection L32 to network node R2. Likewise network node R3 could forward packets for network node R2 via the connection L13 to network node R1, if they are forwarded from there via the connection L12 to network node R2. The routing tables would then be as follows, including the traffic distribution weights p1 and p3, for the alternate paths:

In node R1:

| Destination | Next node | Weight |
|---|---|---|
| D | R2 | 1 − p₁ |
| D | R3 | P₁ |

In node R3:

| Destination | Next node | Weight |
|---|---|---|
| D | R2 | 1 − p₃ |
| D | R1 | P₃ |

Were these routing tables to be used for purely destination-based forwarding decisions, there would be a probability pip3 of the case arising in which for example a packet from network node R1 on the path to network node R2 would first be forwarded via the connection L13 to network node R3 and subsequently onwards from network node R3 via the connection L13 to network node RI. With the probability (plp3)2 this would happen to a packet twice in succession. The probability of a packet being sent backwards and forwards n times would be (pip3)″. Thus the forwarding of packets from network node R1 to network node R2 would not be realized without loops.

In a previous patent application by the applicant with the DPMA file reference 10301265.6 provision is made for resolving this problem by disregarding traffic distribution and instead giving the network nodes locally executable rules. The traffic distribution weighting for the critical alternate paths, that is the potential loops is set to the minimum value, i.e. to zero. The paths are however maintained in the routing table and referred to as a joker links. In addition of the nodes now use the rule that they only use the links provided with the minimum traffic distribution weight if the desired neighboring router or next hop can no longer be reached via any other path which has a positive weight. This simple expansion of the principle of purely destination-based multipath routing of packets remedies the problem of packets traveling in circles, provided only one that link drops out.

The advantage of this method lies in the fact that, especially with multipath routing, an alternative path can be provided which means that no packets circulate in the network. The method operates in this case without taking account of the origin address of packets and without network-wide status information.

This method will be explained on the basis an example. FIG. 1 shows the arrangement of a part of a packet switching data network already described in the introduction. Using the method of operation described there as its starting point, the following entries for the destination D in the routing tables of the network nodes R1 and R3 are now produced for the known method:

In node R1:

| Destination | Next node | Weight |
|---|---|---|
| D | R2 | 1 |
| D | R3 | 0 |

In node R3:

| Destination | Next node | Weight |
|---|---|---|
| D | R2 | 1 |
| D | R1 | 0 |

A packet which arrives at network node R1 for forwarding to destination D is forwarded in the normal case via the primary connection L12 directly to the network node R2. Only if the network node R1 establishes that the connection L12 has dropped out is the distribution weight changed locally for example and further packets for the destination D are forwarded via the alternate routing path L13 to the network node R3. The entries in the routing table of the network node R1 on dropout of the connection L12 would then accordingly be as follows:

In node R1:

| Destination | Next node | Weight |
|---|---|---|
| D | R3 | 1 |

The network node R3 in its turn only forwards the packets directly via its primary connection L32 to the destination network node R2 since in accordance with the same rule it only uses the entry for the destination D in its routing table which has a positive weight.

Only if the network node R2 drops out or if both connections L12 and L32 drop out can in this example packets for the destination D be sent backwards and forwards between network node R1 and network node R3. This produces a “one-hop” routing loop between R1 and R3. Were this only to cause the traffic to destination D to be lost, no great damage would arise since the destination D is not accessible in any event because of the error.

Since the connection L13 and the resources in the network nodes R1 and R3 are also needed by other traffic relationships, this traffic will be massively adversely affected by the packets intended for destination D circulating between R1 and R3. The circulating packets can overload the connection L13 and the network nodes R1 and R3.

### SUMMARY OF INVENTION

An intuitively obvious possibility would be to modify what is known as the packet-forwarding in the router data path so that the network node never sends packets back to the node from which it has received them. Even if one could formulate technical solutions to this problem these are still very complex and demand a drastic modification of the current network node or router Implementations.

An object of the present invention is now to operate a communication network consisting of a number of network nodes so that if joker links are used and if connecting links drop out, routing loops will be avoided.

This object is achieved by with the features of the independent claims.

The advantage of invention lies in the fact that, when joker links are used and two connecting links or connections drop out, a circulation of packets is prevented and thus overloading of connecting links or connections and network nodes is avoided. The invention first specifies a method with which automatically and without the intervention of a central unit, loops which could arise if joker links are used and connection paths fail, are detected and interrupted.

Advantageous developments of the invention are specified in the dependent claims.

In an advantageous embodiment of the invention a message is transmitted at the start of a disruption and at the end of a disruption from a network node to its neighboring network node. This has the advantage that only a minimum number of messages are used for reporting disruptions.

In another advantageous embodiment of the invention what are referred to as keep-alive messages are expanded and used for reporting disruptions. This has the advantage that a known message for reporting disruptions is used and in addition is transferred very quickly and cyclically.

### BRIEF DESCRIPTION OF THE DRAWINGS

The inventive method is explained below on the basis of the arrangement already described in conjunction with the prior art in greater detail in accordance with FIG. 1.

FIG. 1—a prior art arrangement of a part of a packet switching data network.

### DETAILED DESCRIPTION

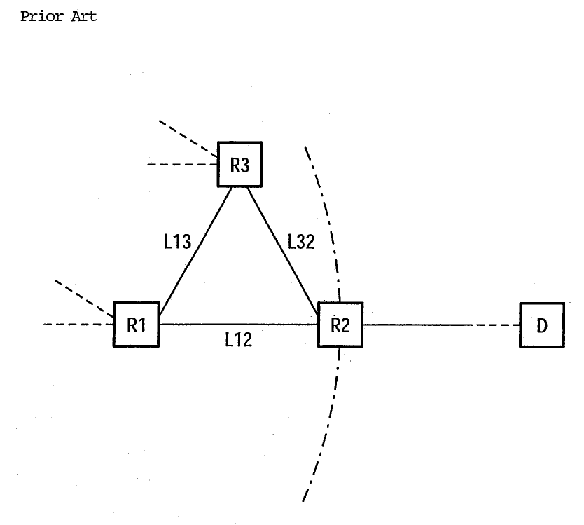

FIG. 1 shows the arrangement of a part of a packet switching data network already described in the introduction. Using the method of operation describe there as its starting point, what is referred to as a one-hop loop occurs if two routers adjoining the joker link, in the example network nodes R1 and R3, each detect a disruption or an error in the direction of the network node R2 and autonomously activate the joker link in their direction.

With the present invention each of the two network nodes R1 and R3 is informed when the network node at the other end of the joker link, in the example R3 or R1, can no longer reach the network node R2.

If the connection L12 is disrupted or has dropped out the network node R1, as described at the start, uses its joker link to the network node R3 to send data packets to the destination D or to the network node R2. In addition, in accordance with the invention, the network node R1 now immediately informs the network node R3 about the failure of the connection L12.

In a similar fashion the network node R3 uses its joker link to the network node R1, if the connection L32 is disrupted or has dropped out, in order to send data packets to the destination D or to the network node R2. In accordance with the invention the network node R3 immediately informs the network node R1 about the failure of the connection L32.

If the link L12 is disrupted which is the primary connection path from the network node R1 to the network node R3 the router uses its joker link which leads via the connection L13 to the network node R3 and sends data packets to the destination D or to the network node R2 by this alternate routing path. Immediately after the occurrence of the disruption and the use of the joker link in the network node R1 the latter sends a message via the connection path L13 to the network node R3 that the link L12 has dropped out and/or the network node R2 is no longer directly accessible via its primary connection path.

After receipt and evaluation of this message in network node R3 the latter knows that the network node R1 can no longer directly reach the network node R2. The network node R3 is now controlled so that the joker link via the connection path L13 to the network node R1 is no longer used for data packets which are sent to destination D or network node R2. This can occur by the joker link being deleted from the routing table in the network node R3. Likewise the joker link can remain in the routing table and can be provided with a marker or a flag to indicate that this link is not currently being used. Many variants are conceivable here.

If the connection path L32 is now also disrupted or has dropped out, the network node R3 knows that the destination D or the network node R2 is no longer accessible via the network node R1 and also not directly via the primary connection path from network node R3 to network node R2. The inactive joker link to network node R1 which may still be present in network node R3, since it is already marked or deleted, is not used. Incoming data packets for destination D or network node R2 are discarded in network node R3 provided network node R2 is not accessible via other network nodes.

Immediately after the disruption in connection L32 network node R3 sends a message to network node R1 that connection L32 has dropped out and/or network node R2 is no longer accessible directly via its primary connection path.

Network node R1 is then controlled so that it takes its active joker link to network node R3 for data packets to destination D or to network node R2 out of operation and discards data packets for the destination D provided the destination D is not accessible via other network nodes.

This means, if both connections L12 and L32 are disrupted or have dropped out, or network node R2 has dropped out, that no packets are sent backwards and forwards on the connection L13 between the network nodes R1 and R3 (ping-pong). The result of this is that the connection L13 and the network nodes R1 and R3 will not be overloaded.

The disrupted link is signaled, as described, by a message being sent from network node R1 to network node R3 and/or vice versa.

The signaling can be implemented by a signal which repeats for as long as the error exists.

The signaling can be implemented by a cyclically repeating message with fault information. The message can be a Protocol Data Unit, abbreviated to PDU, or a packet.

Likewise the signaling can be implemented such that, in the error-free state, signals or messages are sent cyclically which are absent if a disruption or an error occurs. Operation and control of the router is the reverse of that described in the above example in this case. I.e., on absence of the messages an error is detected and an analogous reaction occurs.

The signaling can be implemented by a secured exchange of signals or messages in which for example a message is sent at the beginning of a fault or on occurrence of a fault and a further all-clear message is sent at the end of a fault.

The signaling can also be implemented by a routing protocol or be embedded in a routing protocol. In this case it should be ensured that the signaling is undertaken immediately after the occurrence of a fault so that the connection L13 does not become overloaded. Usual routing protocols require too much time for this.

The signaling can also be implemented by each connection path being checked for errors by an error monitoring system with specific fast packets known as keep-alive packets. In this case the packet format of these keep-alive packets or messages is expanded by fields so that one or more network node numbers can be variably embedded or inserted. If a network node detects a fault on a connection path it inserts the node number of the network node that is not accessible into the keep-alive packets or into its keep-alive stream to the neighboring nodes for as long as the disruption or the error exists. In this way the neighboring network node knows that the network node number inserted in the received keep-alive packets is no longer accessible via this network node and the activation of a joker link to this node would be ineffective.

In the example in accordance with FIG. 1 the network node R1, on failure of the primary connection path L12 to network node R2, would activate its joker link to network node R3 for data traffic to destination D or to network node R2 and would enter in its messages or keep-alive packets which are sent via the connection path L13 or the alternate routing path to network node R3 the network node number of the network node R2. The network node R3 thus knows that no connection path to network node R2 or to destination D is available via network node R1.

If the connection path L32 now fails, the network node R3 does not even put its joker link into operation via connection path L13 to network node R1. Likewise, on arrival of the message with the fault information or the keep-alive packet with the fault information, it could take the joker link out of operation or delete it in its routing table.

As long as network node R1 has no path to network node R2, network node R3 finds the node number of the network node R2 in the keep-alive packets of network node R1. Where the network node R3 has a joker link in operation to network node R2 or destination D via network node R1, it takes it out of operation.

Only if network node R1 no longer reports the router number of network node R2 in the messages or keep-alive packets, connection path L12 fault-free again or a connection path exists again between network node R1 and network node R2 may the network node R3 put its joker link (back) into operation.

In the case of dropout of network node R2 or of the two connections L12 and L32, both network nodes R1 and R3 would insert or inject the router number of the network node R2 into the relevant keep-alive packets and not operate both joker links or take them out operation.

Only when one of the two network nodes R1 or R3 has a path again can the other network node activate a joker link where necessary.

In this way loops are avoided or, should they occur because of a simultaneous activation of the joker in both directions, they are immediately cleared down.

Alternatively a network node can inject the network node number of a network node actually accessible, in this case network node R2, before a joker link is put into operation and only activate its joker link after a guard time. For example inject the network node number for n keep-alive packet periods and only if after a certain time the neighboring router does not report an error, activate its joker link and remove the network node number inserted for testing.

The outstanding feature of the method is that it is very fast and prevents overloads of the connection paths. This is especially advantageous for transmission of voice data (Voice over IP), since delays or losses of voice data with overloaded connection paths are especially disadvantageous here. Routing protocols which exchange information about faulty or dropped-out connection paths are significantly slower than the method described. In addition re-routing which may not be desired is often triggered in these cases.

The method in accordance with the invention can be realized by a simple-to implement software solution.

The invention is claimed as follows:

1. A method for reporting a dropped-out connection path of a first network node to a second network node within a packet switching communication network, comprising:
providing a first routing table to the first node, the first routing table including a primary entry representing a primary routing path and an alternate entry representing an alternate routing path,
wherein the primary path is a connection path between the first node and the destination node, and
wherein the alternate path is a connection path between the first node and the destination node via the second node;
providing a second routing table to the second node, the second routing table including a primary entry representing a primary routing path and an alternate entry representing an alternate routing path,
wherein the primary path is a connection path between the second node and the destination node, and
wherein the alternate path is a connection path between the second node and the destination node via the first node;
detecting a first fault by the first node of the primary path of the first node;
reporting the first fault detected by the first node to the second node;
detecting a second fault by the second node of the primary path of the second node; inhibiting a transfer of a data packet to the destination network node via the alternate path of the second node; and
reporting the second fault detected by the second node to the first node,
wherein the relevant alternate routing path entry is used if there is a fault on the primary routing path,
whereby a transfer back and forth between the first and second nodes of a data packet to be sent towards the destination network is inhibited, thereby reducing a load of the first and second nodes.

2. The method according to claim 1, wherein the first and/or second fault is reported via sending a message.

3. The method according to claim 2, wherein the message is sent substantially immediately after the detection of the respective fault.

4. The method according to claim 2, wherein the message is transferred cyclically on the primary connection path.

5. The method according to claim 1, wherein the transfer of the data packet is prevented.

6. The method according to claim 1, wherein the first and/or second fault is reported via a routing protocol.

7. The method according to claim 2, further comprising: reporting the first fault to a neighboring node respective to the first node; and informing the neighboring node after the end of the first fault.

8. The method according to claim 7, wherein the fault is reported to the neighboring node within a keep-alive message.

9. The method according to claim 7, wherein a node identifier of the first node is used to report the fault to the neighboring node.

10. The method according to claim 2, further comprising: informing a neighboring node respective to the second node of the second fault; and
informing the neighboring node after the end of the second fault.

11. The method according to claim 10, wherein the fault is reported to the neighboring node within a keep-alive message.

12. The method according to claim 10, wherein a node identifier of first node is used to report the fault to the neighboring node.

13. A method for reporting a dropped-out connection path of a first network node to a second network node within a packet switching communication network, comprising:
providing a first routing table to the first node, the first routing table including a primary entry representing a primary routing path and an alternate entry representing an alternate routing path,
wherein the primary path is a connection path between the first node and the destination node, and
wherein the alternate path is a connection path between the first node and the destination node via the second node;
providing a second routing table to the second node, the second routing table including a primary entry representing a primary routing path and an alternate entry representing an alternate routing path,
wherein the primary path is a connection path between the second node and the destination node, and
wherein the alternate path is a connection path between the second node and the destination node via the first node;
periodically transferring a message from the first node to the second node while the first node has access to the destination network node via the respective primary path;
stopping the periodic transfer when a first fault is detected on the primary path of the first node;
detecting a second fault on the primary path of the second node; and
avoiding a transfer of a data packet to the destination node via the alternate routing path that leads from the second node to the first node.

14. The method according to claim 13, wherein the transfer of the data packet is prevented.

15. A first network node within a packet switching communication network having a first primary path that is a connection path between the first node and a destination node and a first alternate path that is a connection path between the first node and a second node, and the second node having a second primary path that is a connection path between the second node and the destination node and a second alternate path that is a connection path between the second node and the first node, the first node comprising:
a routing table including a primary entry representing the first primary path and an alternate entry representing the first alternate path;
a first fault indicator that indicates if the first primary path is available;
a second fault indicator that indicates if the second primary path is available to the second node; and
a receiver that receives a data packet to be transferred to the destination node;
wherein when the first and second fault indicators indicates the paths are unavailable, transfer of the data packet on the first paths is inhibited.

16. The node according to claim 15, wherein when the first fault indicator indicates that the first primary path is available, a message is periodically sent the second node to indicate that the path is available.

17. The node according to claim 16, wherein when the first fault indicator indicates that the first primary path is unavailable, the first node stops sending the periodic message.

18. The node according to claim 15,
wherein within a time period the first node receives a periodic message from the second node to indicate that the second primary path is available, in which the second fault indicator is set to indicate that the second primary path is available, and
wherein within the time period the first node does not receive the periodic message and the second fault indicator is set to indicate that the second primary path is unavailable.
